(19) United States
(12) Patent Application Publication
(10) Pub. No.: US 2016/0309701 A1
(43) Pub. Date: Oct. 27, 2016

(54) Heated Animal Scent Dispenser

(71) Applicant: James DeHaven, Hazleton, IN (US)

(72) Inventor: James DeHaven, Hazleton, IN (US)

(21) Appl. No.: 15/084,652

(22) Filed: Mar. 30, 2016

Related U.S. Application Data
(60) Provisional application No. 62/139,882, filed on Mar. 30, 2015.

(51) Int. Cl. A01M 31/00

(52) U.S. Cl. CPC A01M 31/008

(57) ABSTRACT

A device for dispensing animal scent having a housing that includes first and second interior compartments, a first lid that attaches to the first compartment, and a second lid that is hinged to the second compartment. The hinged second lid having a closed position and an open, functional position. The first compartment for receiving a battery that is in electrical communication with a heating element and wick that is received in the second compartment. The liquid scent lure is poured into the second compartment such that a lower end portion of the wick is submerged in the liquid. The heating element then applies heat to the upper-end of the wick through which a liquid scent is drawn by capillary action. The heated liquid scent rapidly volatilizes and becomes dispensed into ambient air from the exposed portion of the wick. The second lid defines an interior spacing. The upper portion of the wick through which the liquid scent is drawn is maintained in the defined spacing so that when the second lid is in the open position, the upper portion of the wick is exposed to improve the vaporization process.

### CROSS REFERENCES TO RELATED APPLICATIONS

U.S. Provisional Application for Patent No. 62/139,882, filed Mar. 30, 2015, with title “Heated Animal Scent Dispenser” which is hereby incorporated by reference. Applicant claims priority pursuant to 35 U.S.C. Par. 119(e)(i).

### STATEMENT AS TO RIGHTS TO INVENTIONS MADE UNDER FEDERAL SPONSORED RESEARCH AND DEVELOPMENT

Not Applicable.

### BACKGROUND OF THE INVENTION

1. Field of the Invention

This invention relates generally to a hunting device, and more particularly to a hunting device for carrying, retaining, and heating animal scent that attracts prey.

2. Brief Description of Prior Art

Hunters of deer and other game animals frequently will rely on some type of animal lure to assist them in tracking and sighting game. Often, the lure a hunter employs is a scented substance, the odor of which is an animal attractant.

Many of the commercially available scented substances are provided in liquid form and may be used in a variety of ways. One way is to pour the liquid scent lure onto absorbent pads, which are then hung on branches or twigs where the scent is allowed to vaporize into the ambient air to attract the animals. Another way is to pour the liquid scent lure onto trees or on the ground at either real or artificially created scrapes where a horned animal might mark his territory. The liquid scents may also be dripped in a controlled manner on either the real or artificial scrape.

Cold weather has a severe and adverse effect in the vaporization of the liquid scent lure. In subfreezing conditions, the liquid scent may actually freeze and thereby render the product far less effective. In above-subfreezing conditions, the vaporization may be greatly slowed.

In view of the cold weather problem, there have been efforts to improve the vaporization process. One effort is to place a battery operated heating element within a wick which is placed within an open bottle. Another method is to leave the bottle open and place a heating means about the bottle to heal the scent liquid. However, these methods are inefficient in actually warming the liquid scent lure to anywhere near animal body temperature.

Consequently, there is a need for a highly efficient dispenser that will readily warm the liquid animal scent lure from within a container while the lure is substantially outside the container having a surface area for scent dissipation. The dispenser should also be waterproof to assure that rain will not stop the heat. Lastly, the dispenser should be readily inoperable when no longer in use and readily operable for use.

Therefore, the principal object of the present invention is to provide an improved device for carrying, retaining and heating animal scent that minimizes the restriction of aeration of the scent.

### SUMMARY OF THE INVENTION

A device for dispensing animal scent having a housing that includes first and second interior compartments, and a first lid that attaches to the first compartment, and a second lid attached to the second compartment. The second lid having a closed position and an open, functional position. The first compartment for receiving a battery that is in electrical communication with a heating element and wick that is received in the second compartment. The liquid scent lure is poured into the second compartment such that a lower end portion of the wick is submerged in the liquid. The heating element then applies heat to the upper-end of the wick through which a liquid scent is drawn by capillary action. The heated liquid scent rapidly volatilizes and becomes dispensed into ambient air from the exposed portion of the wick.

The second lid defines an interior spacing. The upper portion of the wick through which the liquid scent is drawn is maintained in the defined spacing so that when the second lid is in the open position, the upper portion of the wick is exposed to improve the vaporization process. In the closed position, the liquid scent as well as the heating element and wick are protected from the elements and ready for transportation without having to remove the components from the second compartment.

### BRIEF DESCRIPTION OF THE DRAWINGS

FIG. 1 is a top perspective view of the present invention, a heated animal scent dispenser.

FIG. 2 is a top view of the dispenser illustrated in FIG. 1.

FIG. 3 is a perspective view of the dispenser's outer housing.

FIG. 4 is a sectional view thereof, taken from line 4-4 in FIG. 2,

FIG. 5 shows the dispenser's first and second lids, seal and slider member.

FIG. 6 shows the dispenser's slider member and heating element of the present invention.

FIG. 7 is an exploded view of the dispenser's slider member, heating element and wick.

### DESCRIPTION OF THE PREFERRED EMBODIMENT

The following description of the preferred embodiment is merely exemplary in nature and is in no way intended to limit the invention, its application, or uses.

The present invention is directed to a hunting device for carrying, retaining, and heating animal scent that attracts prey. More particularly, the present invention incorporates a highly efficient design for a scent dispenser that will readily warm the liquid animal scent lure from within the dispenser and having a surface area for scent dissipation. In the broadest context, the heated animal scent dispenser of the present invention consists of components configured and correlated with respect to each other so as to attain the desired objective.

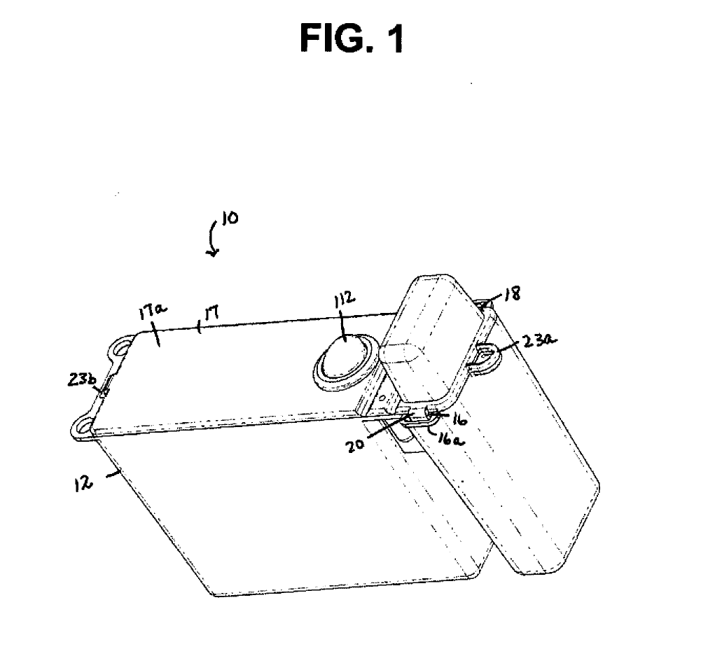

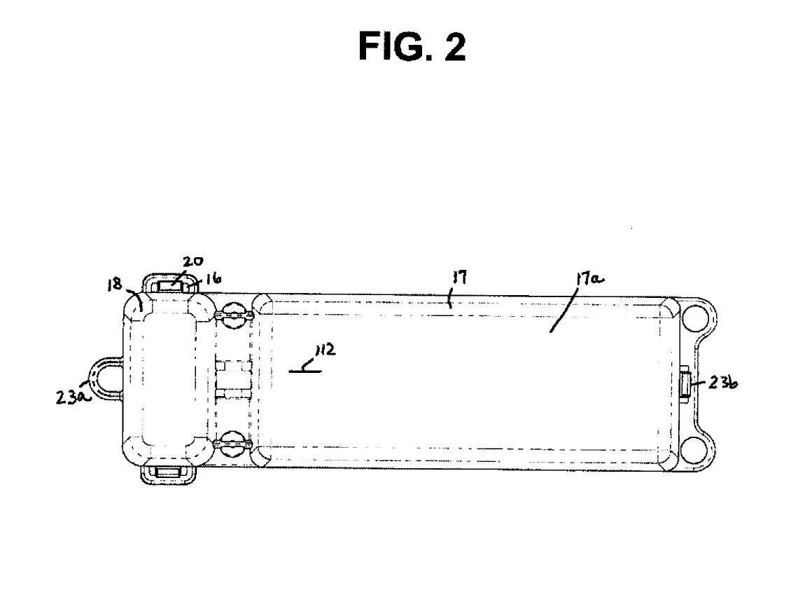

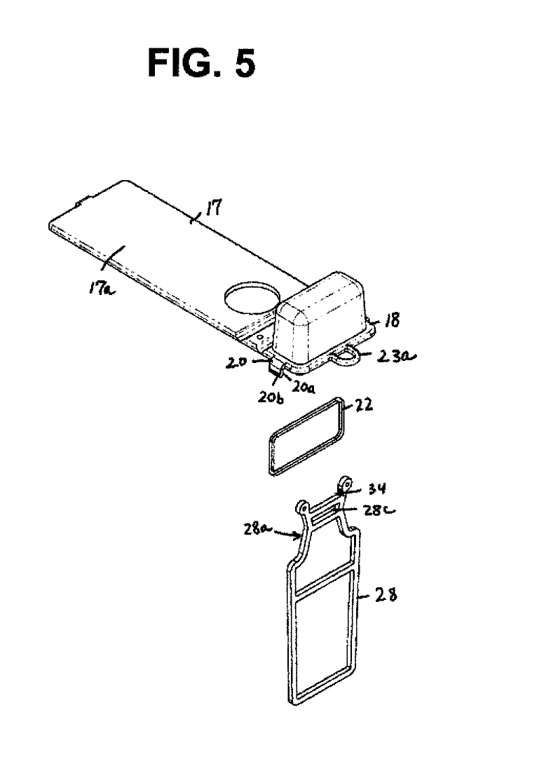

The device for dispensing animal scent comprising the present invention is shown generally in FIGS. 1-7, the device designated as numeral 10.

The device is generally comprised of a rigid, outer housing 12 that includes an interior 13, the interior 13 having first and second compartments 14, 15, respectively. As illustrated, the first compartment 14 includes an inside wall 14a and the second compartment 15 includes an inside wall 15a with a first spacing 21 therebetween. The housing 12 includes a first lid 17 that is releasably attached to the first compartment 14, and a second lid 18 that is releasably attached to the second compartment 15. The second lid 18 includes a pair of L-shaped tabs 20 that are on opposite sides of the second lid 18, and that are received in a pair of openings 16 on the second compartment 15 that coincide with the tabs 20 and are sized for receiving the distal end 20a of each of the tabs 20. Each distal end 20a defines a catch 20b that engages a lower surface 16a of the opening 16.

The tabs 20 are constructed of a plastic material such that manually inwardly pressing the tabs 20 can disengage the catch 20b of the tabs 20 from the openings 16 to open the second compartment 15. For this purpose, the user can release and lift the second lid 18 from the second compartment 15 to have access to the second compartment's 18 contents as will be discussed. As such, the second lid 18 does not open automatically; the lid 18 must be released manually as disclosed.

The second lid 18 having a closed position as shown in FIG. 1 and as will be discussed, an open, functional position where the second lid 18 is removed from the second compartment 15 during application. Sealer 22 such as an O-ring or the like is used to provide desired sealing between the second compartment 15 and the lid 18. Similarly, a seal (not shown) is preferably disposed between the first compartment 14 and the first lid 17.

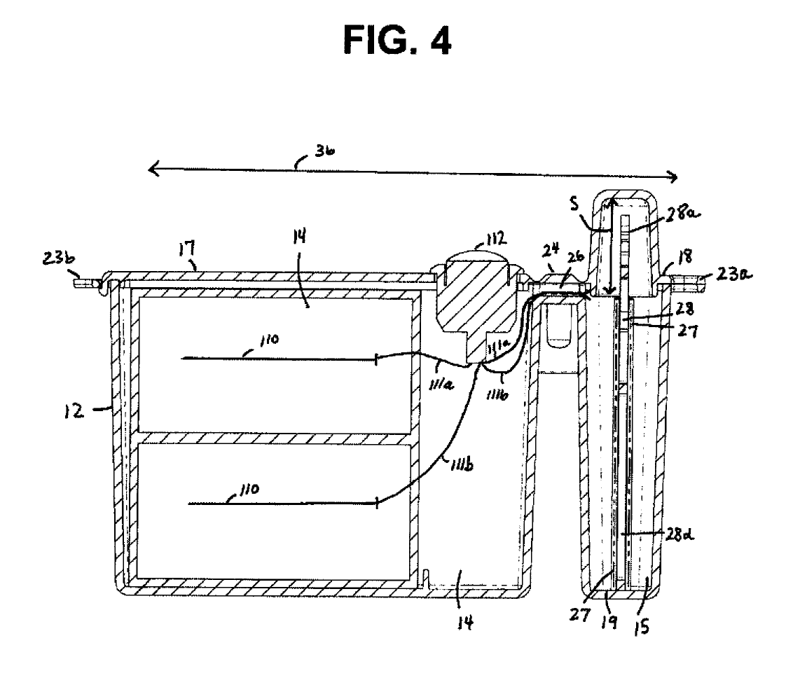

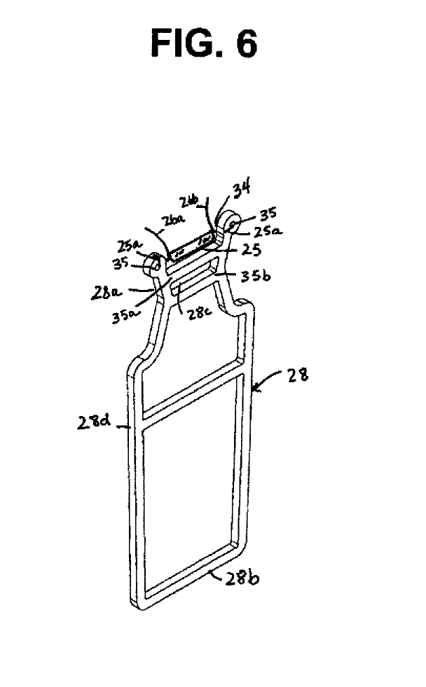

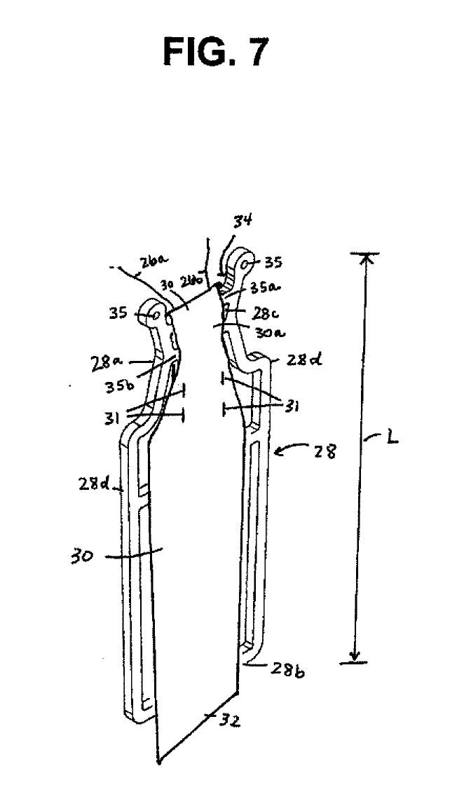

Referring now to FIG. 4, a side, sectional view of the device 10 is illustrated. The first compartment 14, having the larger interior is configured for receiving, in the preferred embodiment, a battery 110 therein. The battery 110 is a conventional battery that as will be described, is in electrical communication with a heating element 25 (see FIG. 6) that is in communication with a wick 30 (see FIG. 7). The heating element 25 and wick 30 is disposed in the second compartment 15.

The second compartment 15 further defines a pair of tracks 27 on opposing sides that slideably receive edge 28d of a slider member 28. The slider 28 including an upper handle-end 28a for vertically guiding the slider 28 upwardly and downwardly along the tracks 27 of the second compartment 15, and removing the slider 28 from the tracks 27. The slider 28 also includes an opposite end 28b that in application, is adjacent a lower inside surface 19 of the second compartment 15.

In application, the heating element 25 is appropriately attached to the handle-end 28a of the slider 28 and the wick 30 is likewise attached to the handle-end 28a, in communication with the heating element 25, and downwardly extends parallel with the length L of the slider 28.

Referring to FIGS. 6 and 7, the handle-end 28a defines an area 34 for receiving the heating element 25 and further includes apertures 35 for releasably receiving attachment wires 25a of the heating element 25. In one embodiment, (as illustrated) the attachment wires 25a pass through the apertures 35 and wrap around the handle-end 28a to releasably maintain the heating element 25 within the area 35.

As will be discussed, the heating element 25 further includes a positive and negative contact 26a, 26b respectively for electrically connecting with the battery 110.

Preferably, a loop 28c is defined by first and second members 35a, 35b, respectively of the upper handle-end 28a of the slider 28. The first and second members 35a, 35b, as well as the loop 28c are perpendicular to the length L.

In application, it is important that the wick 30 is attached to the slider 27 such that the upper portion 30a of the wick 30 is in contact with the heating element 25. As shown in FIG. 7, the upper portion 30a preferably wraps over the heating element 25 and is then appropriately attached to one of the members 35a, 35b. Alternatively, the upper portion 30a may first wrap over the heating element 25 and then pass through the loop 28c and then appropriately attached 31. As shown, the wick 30 downwardly extends parallel with the length L of slider 28. As illustrated, preferably, the wick 30 extends substantially the length L of the slider 28 such that an end 32 of the wick is adjacent or nearly adjacent the lower inside surface 19.

As such, inserting the slider 28 into the second compartment 15 as discussed, further positions the heating element 25 and wick 30 within the second compartment 15, and removing the slider 28 from the second compartment 15 as discussed similarly removes the heating element 25 and wick 30 from the second compartment 15.

In the preferred embodiment, the heating element 25 is a heat generating electric resistor that as described, is in communication with the wick 30.

The heating element 25 includes a positive contact 26a and a negative contact 26b. In application, the battery 110 is disposed within the first compartment 14 and first and second wires 111 a, 111 b, are appropriately connected between the battery 110 and the heating element 25. In particular, first wire 111a is appropriately connected at one end to the battery's positive contact 110a and the opposite end of the wire 111a is electrically connected to the contact 26a (positive) of the heating element 25 and, second wire 111b is appropriately connected at one end to the battery's negative contact 110b, and the opposite end of the wire 111b electrically connected to the contact 26b (negative) of the heating element 25.

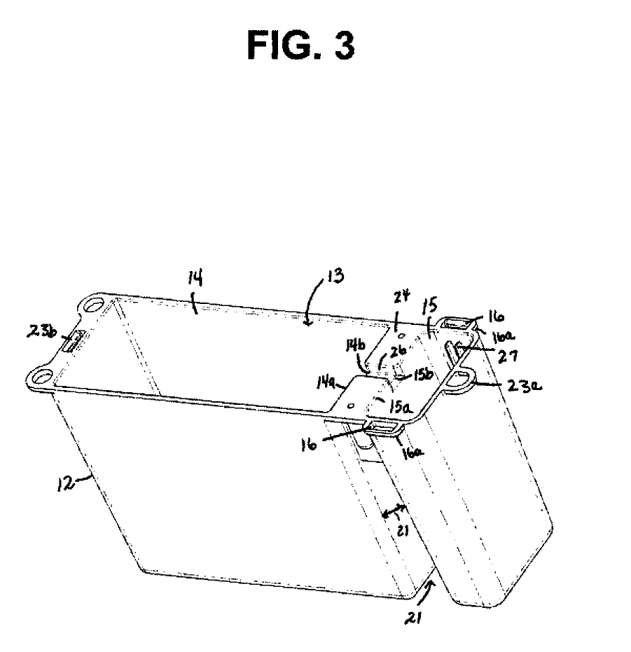

As best seen in FIG. 3, outer housing 12 includes a bridge 24 that joins the first compartment 14 and second compartment 15. The bridge 24 defines a path 26 that is aligned with a first notch 14b defined in an upper edge of the inside wall 14a, 14, and aligned with a second notch 15b defined in an upper edge of the inside wall 15a. The path 26 and notches 14b, 15b for receiving the wires 111a, 111b as they extend from the first compartment 14 to the second compartment 15 as described. In the alternative, the inside walls 14a, 15a may each include an aperture (not shown) in an approximate upper portion of the walls 14a, 15a for passing the wires from the interior of the first compartment 14 to the interior of the second compartment 15 for electrical communication.

The liquid scent lure (not shown) is poured into the second compartment 15. The slider 28 having the heating element 25 and wick 30 attached are received within the second compartment 15 as described such that the lower end portion 32 of the wick 30 is submerged in the liquid. The heating element 25 then applies heat to the upper portion 30a of the wick 30 through which a liquid scent is drawn by capillary action. The heated liquid scent rapidly volatilizes and becomes dispensed into ambient air from the exposed portion of the wick.

As illustrated in FIG. 4, the second lid 18 defines an upper interior spacing S. The second lid 18 having a closed position for storage and transportation, and an open position, which is the functional position during application. The upper portion 30a of the wick 30 through which the liquid scent is drawn is preferably maintained in the defined upper spacing S when the lid 18 is closed, so that when the lid 18 is in the open position, the upper portion 30a of the wick 30 is exposed to improve the vaporization process. In the closed position, the liquid scent as well as the heating element 25 and wick 30 are protected from the elements and ready for transportation without having to remove the components from the second compartment.

The second compartment 15 further includes an eyelet 23a that is provided to suspend the dispenser 10, in the open position, from a branch or other support object using a first cord (not shown). As illustrated in FIG. 4, the eyelet 23a is parallel with a longitudinal axis 36 of the outer housing 12. Similarly, the first compartment includes a slot 23b, opposite the eyelet 23a, for suspending the dispenser 10 in the open position. in particular, one end of a second cord (not shown) is attached to the eyelet 23a and the opposite end of the second cord attached to the slot 23b. The first cord is then attached at one end to the support object and attached at the opposite end to the approximate center of the second cord thereby suspending the dispenser 10.

The wick 30 is comprised of an absorbent material commonly used in the science, which can be repeatedly dampened, or even saturated, with attractant, thereby maintaining the effectiveness of the apparatus in attracting animals. The wick 30 can also be entirely replaced when necessary.

The wick 30 is appropriately of a thickness to have insulation qualities to slow the heat dissipation from within the interior 13 of dispenser 10 which heats the scent lure and creates the heated scent lure dispersion.

The device 10 is designed to be carried around in the closed position, wherein the upper lids 17 and 18 are secured to the outer housing 12 until it is so desired to allow the attractant to diffuse into the air.

When it is desired to open the device 10, the dispenser 10 is grasped and the second lid's opposite tabs 20 are released so that the lid 18 can be removed and the upper portion of the wick 30 is exposed to air or oxygen. If the heating element 25 and wick 30 are not already positioned in the second compartment, the slider 28 is removed from the second compartment, and the heating element 25 and wick 30 are attached with the slider 28 as previously described. The scented liquid lure is received in the second compartment 15 and the slider 28 is then inserted positioning the heating element 25 and wick 30 within the second compartment 15.

Next, the dispenser 10 is positioned and hung from a branch or a twig as previously described. On/off switch 112 is preferably disposed on the top surface 17a of the first lid 17. As illustrated, switch 112 is electrically connected to the battery 110 and the heating element 25 such that turning electrical means (battery) 110 to the on position begins the heating process of the heating element 25 and wick 30 for dispersion of the scent lure. In the preferred embodiment, switch 112 is an LED switch.

Although the description above contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

It would be obvious to those skilled in the art that modifications may be made to the embodiments described above without departing from the scope of the present invention. Thus the scope of the invention should be determined by the appended claims in the formal application and their legal equivalence, rather than by the examples given.

1. An animal scent dispenser comprising:
a first compartment having a first lid, and a second compartment having a second lid,
an electrical source disposed in said first compartment electrically coupled to a heating element disposed in said second compartment,
a slider member received in said second compartment, said slider member having an upper-end that includes a loop that is perpendicular to a length of said slider member, wherein said heating element is attached to said upper-end, and a wick is attached with said loop and downwardly extends parallel with the length of said slider member,
a supply of liquid animal scent contained within said second compartment,
whereby inserting the slider member and said wick into the second compartment submerges a lower portion of said wick with the liquid scent, and
wherein said second lid further defines an upper interior spacing such that in a closed position the upper-end of the slider member is within said interior spacing and in an open position said upper-end is exposed to ambient air.

2. The dispenser as recited in claim 1, wherein said second compartment further includes an eyelet that is parallel with a longitudinal axis, and said first compartment includes a slot, opposite the eyelet.

3. The dispenser of claim 2, wherein said second lid further includes a pair of tabs that are received in a pair of openings on the second compartment that coincide with said tabs, and wherein each of said tabs define a catch that engage a lower surface of the opening, and wherein manually inwardly pressing the tabs disengage the catch from the opening.

4. The dispenser of claim 3, wherein said second compartment further defines a pair of tracks that slidingly receive said slider member.

5. The dispenser as recited in claim 4, wherein said upper-end further defines an area for receiving said heating element.

6. The dispenser as recited in claim 5, wherein said upper-end further includes apertures for releasably receiving attachment wires of said heating element.

7. The dispenser as recited in claim 6, wherein said loop is defined by first and second members that are perpendicular to said length.

8. The dispenser as recited in claim 7, wherein said wick extends substantially the length of said slider member such that a lower end of said wick is adjacent a lower inside surface of said second compartment.

9. The dispenser as recited in claim 8, wherein a path is disposed between said first compartment and said second compartment for receiving electrical wires that extend from said electrical source to said heating element.

10. The dispenser as recited in claim 9, wherein said first compartment includes a switch in electrical communication with said power source and with said heating element.

11. The dispenser of claim 10, wherein said switch includes a button disposed on a top surface of said first lid.

12. The dispenser of claim 11, wherein said switch is an LED switch.

13. The dispenser as recited in claim 1, wherein said heating element is a heat generating electric resistor.

14. An animal scent dispenser comprising:
a first compartment having a first lid, and a second compartment having a second lid,
an electrical source disposed in said first compartment electrically coupled to a heating element disposed in said second compartment,
a slider member received in said second compartment, said slider member having an upper-end that includes a cross-member that is parallel to a longitudinal axis, wherein said heating element is attached to said upper-end,
and a wick is attached to said cross-member and downwardly extends parallel with a length of said slider member,
an eyelet extending from said second compartment and parallel with said longitudinal axis,
a slot extending from said first compartment, opposite said eyelet,
a supply of liquid animal scent contained within said second compartment,
whereby inserting the slider member and said wick into the second compartment submerges a lower portion of said wick within the liquid scent,
wherein said second lid further defines an upper interior spacing such that in a closed position the upper-end of the slider member is within said upper interior spacing and in an open position said upper-end is exposed to ambient air.

15. The dispenser of claim 14, wherein said second lid further includes a pair of tabs configured to be received in a pair of openings on the second compartment, and wherein manually inwardly pressing the tabs disengage the pair of tabs from the pair of openings.

16. The dispenser as recited in claim 15, wherein said upper-end further defines an area for receiving said heating element.

17. The dispenser as recited in claim 16, wherein said upper-end further includes apertures adjacent said area for releasably receiving attachment wires of said heating element.

18. The dispenser as recited in claim 17, wherein a path is disposed between said first compartment and said second compartment for receiving electrical wires that extend from said electrical source to said heating element.

19. An animal scent dispenser comprising:
a housing including a first compartment and a second compartment,
said first compartment having a first lid, and said second compartment having a second lid,
an electrical source disposed in said first compartment electrically coupled to a heating element disposed in said second compartment,
wherein a bridge joins said first and second compartments, said bridge including a path that is aligned with a first notch in the first compartment and a second notch in the second compartment for receiving electrical wires that extend from said electrical source to said heating element,
a slider member received in said second compartment, said slider member having an upper-end configured for receiving said heating element, and a wick having an upper portion that is attached to said upper-end and downwardly extending parallel with a length of said slider member,
an eyelet extending from said second compartment and parallel with said longitudinal axis,
a slot extending from said first compartment, said slot and said eyelet on opposite ends of said housing,
a supply of liquid animal scent contained within said second compartment, whereby inserting the slider member and said wick into the second compartment submerges a lower end of said wick within the liquid scent,
wherein said second lid further defines an upper interior spacing such that in a closed position the upper-end of the slider member is enclosed in said second compartment and in an open position said upper-end is exposed to ambient air.

20. The dispenser of claim 19, wherein said second lid further includes a pair of tabs configured to be received in a pair of openings on the second compartment, and wherein manually inwardly pressing the tabs disengage the second lid from the second compartment.
